(19) United States
(12) Patent Application Publication
(10) Pub. No.: US 2024/0144106 A1
(43) Pub. Date: May 2, 2024

(54) ATTRIBUTE-BASED CALIBRATION FOR MACHINE LEARNING

(71) Applicant: INTERNATIONAL BUSINESS MACHINES CORPORATION, Armonk, NY (US)

(72) Inventors: Michele Merler, New York, NY (US); Paul Pritz, London (GB)

(21) Appl. No.: 17/977,880

(22) Filed: Oct. 31, 2022

(51) Int. Cl. G06N 20/20

(52) U.S. Cl. CPC G06N 20/20

(57) ABSTRACT

Machine learning classification using attribute-based calibration can include encoding a set of features extracted from computer-readable data associated with an object, the set of features describing one or more predetermined aspects of the object. A set of attribute predictions can be generated based on the set of features. The set of attribute predictions can be generated by a machine learning model that is capable of generating predictions for unseen attributes and that is trained using an attributes-level loss function. The attributes-level loss function can include an unseen attributes loss component that is computed only with respect unseen attributes. The set of attribute predications can be mapped to a set of predetermined attributes corresponding to one of a plurality of predetermined classes. An output of the machine learning classification is the classification of the object based on the mapping.

### BACKGROUND

This disclosure relates to machine learning and, more particularly, to the computer-determined classification of computer inputs using classification models generated with machine learning.

Machine learning classification is performed by a computer program that “learns” to predict which of k categories that an object belongs to, the classification based on computer input that describes features or aspects of the object to be classified. The computer input can be a data structure such as a feature vector, matrix, or higher-order tensor. Classification of objects is performed with a variety of different computer-based applications for classifying objects such as text, images, sounds, network traffic, and IoT devices, for example. Image classification, for example, can be performed by training a machine using supervised learning to predict which of k categories that an image belongs to, the prediction based on pixel values of the image. Machine learning classification, for example, can be used to detect and classify a newly introduced IoT device that is attempting to connect, or has connected recently, to a network.

One approach for classifying objects using machine learning is supervised learning. Examples of supervised learning algorithms include Support Vector Machine classifiers, Random Forest classifiers, and naïve Bayes classifiers, which are capable of predicting two or more classes. A widely used supervised learning approach for performing object classification is deep learning, implemented, for example, with a neural network (NN) comprising one or more hidden layers. Deep learning NNs provide especially good results but are restricted to predicting only those classes that the NN has encountered during the learning phase.

Another approach for performing object classification using supervised learning is zero shot learning (ZSL). ZSL extends a multi-hidden layer neural network by incorporating auxiliary information to predict unseen classes. An unseen class is one not seen among the labeled training examples used to train the ZSL model. Auxiliary information defines certain attributes for objects belonging to a specified class. The ZSL model predicts attributes of an object, and based on the attribute predictions, predicts the class to which the object belongs. The ZSL can classify an object belonging to a class not seen during training based on the auxiliary information presented as an attribute vector. A lookup table can cross reference the attribute vector and a particular class, thus classifying the object without having previously seen an example from that class.

Still another approach for performing object classification using supervised learning is generalized zero-shot learning (GZSL) using deep calibration. The GZSL extends the ZSL to overcome a ZSL limitation. The ZSL is adversely affected by domain shift, which results from the fact that the model generates much higher scores for seen classes relative to unseen (or underrepresented) classes. As a result, the ZSL fails to reliably predict classes not seen during the model's training. GZSL mitigates domain shift by adding a class-level loss component that is computed with respect to unseen classes.

Neither ZSL nor GZSL, however, is capable of efficiently processing and predicting classes based on unseen attributes, that is, attributes present only in unseen classes and thus not included among any of the examples used to train the ZSL or GZSL model.

### SUMMARY

In one or more embodiments, a method includes encoding a set of features extracted from computer-readable data associated with an object, the features describing one or more predetermined aspects of the object to be classified. The method includes generating a set of attribute predictions based on the set of features. The set of attribute predictions is determined by a machine learning model that is capable of generating predictions for unseen attributes and that is trained using an attributes-level loss function that includes an unseen attributes loss component, which is computed only with respect to unseen attributes. Additionally, the method includes mapping the set of attribute predictions to a set of predetermined attributes corresponding to one of a plurality of predetermined classes. The method also includes outputting a classification of the object based on the mapping.

In one aspect, the attributes-level loss function includes a seen attributes loss component that is computed only with respect to seen attributes. The attributes-level loss function can measure prediction errors in training the machine learning model by summing the seen attributes loss component and the unseen attributes loss component.

In another aspect, prior to summing the seen attributes loss component and the unseen attributes loss component, the unseen attributes loss component is multiplied by a weighting coefficient. The weighting coefficient is selected to mitigate an imbalance among a set of training examples used to train the machine learning model.

In another aspect, the unseen attributes loss component is an entropy-based loss. The seen attributes loss component can be a cross-entropy loss or other loss term, such as a mean square error.

In another aspect, a notification that the object corresponds to a new class is generated in response to determining that the object does not correspond to any of the plurality of predetermined classes. Optionally, an output identifying one or more attributes of the new class can also be generated.

In one or more embodiments, a system includes a processor configured to initiate executable operations as described within this disclosure.

In one or more embodiments, a computer program product includes one or more computer readable storage mediums having program code stored thereon. The program code is executable by a processor to initiate executable operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing a machine learning attribute-based calibration (ABC/ML) framework.

FIG. 2 illustrates an example architecture for the executable ABC/ML framework of FIG. 1.

FIG. 3 illustrates an example method of operation of the ABC/ML framework of FIGS. 1 and 2.

FIGS. 4A-4F illustrate an example experiment comparing the predictive performance of a computer implementation of the ABC/ML framework with that of a GZSL implementation in classifying IoT devices based on seen and unseen attributes.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and, more particularly, to computer-implemented classifications of computer inputs using classification models generated with machine learning. In accordance with the inventive arrangements disclosed herein, methods, systems, and computer program products are provided that are capable of classifying objects whose classifications depend on unseen attributes. An “unseen attribute,” as defined herein, is an attribute that has not been seen by a machine learning model during the training of the model using supervised learning. Therefore, by definition, the unseen attribute is an attribute corresponding to an unseen class—that is, a class for which none of the examples used to train the machine learning model belong.

Machine learning methodologies such as ZSL and GZSL are adapted to the classification of objects belonging to unseen classes. Both methodologies, however, fail to overcome the limitations imposed by unseen attributes. ZSL and GZSL rely on all attributes—both those for objects from seen classes and those for objects from unseen classes—being presented during the training phase. Thus, all attributes that are present for an unseen class must also be present for at least one seen class. Using this terminology, an attribute is “present” if an element of a vector, matrix, or higher-order tensor corresponding to the attribute is one, and the attribute is “not present” if the element is zero.

The inventive arrangements disclosed herein overcome the limitations imposed by unseen attributes. In one aspect, the inventive arrangements introduce an entropy penalty into the training of a machine learning model that learns to predict attributes. Specifically, an entropy-based component is introduced into the loss function of an attribute classifier. The entropy-based component penalizes high-certainty predictions of zero probability for unseen attributes in examples that do not represent the unseen attributes. The penalty thereby makes the predictions on the absence of unseen attributes less certain during the training phase, therefore enabling higher score predictions of unseen attributes at test time and in subsequent post-training classifications performed with the trained model. Without the penalty, high certainty of zero probability during training makes it likely that the model once trained without ever seeing an attribute will, with confidence, never predict the unseen attribute post-training. The model will tend to always, or nearly always, predict that the occurrence of the unseen attribute has zero probability. Penalizing high-certainty zero probability predictions obviates, or at least significantly mitigates, the tendency and thus enable more accurate predictions of unseen attributes at test time and in subsequent classifications performed post-training. Unseen attributes, in various contexts, are the discriminating attributes for a particular class. Accordingly, in such contexts, predicting unseen attributes significantly impacts the accuracy with which objects are classified.

Another aspect of the inventive arrangements disclosed herein is the introduction of entropy penalties for attribute prediction within the attribute domain rather than at the class level, as with other machine learning techniques such as ZSL and GZSL. This not only enables the prediction of unseen attributes and enhanced classification capabilities of machine learning, but also mitigates the likely overfitting of a machine learning model. Moreover, the imposition of a weighted attributes-level entropy loss on the machine learning model mitigates the effects of dataset imbalance. Unseen attributes are the most extreme case of dataset imbalance, since they have zero examples at training time, while other attributes have some number of examples in the training data. In the case were some attribute classes present few examples, while other attributes have lots of examples, adding a weighted attributes level entropy term to the training loss can mitigate the effects of the data imbalance, by forcing higher probability score prediction values for examples in underrepresented attributes classes.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

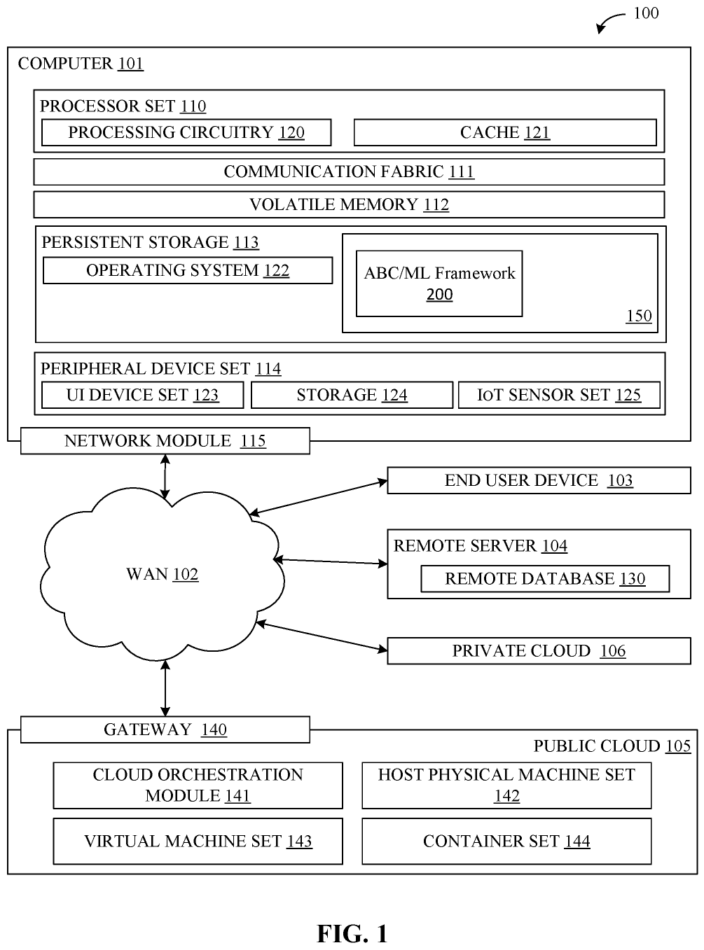

Referring to FIG. 1, computing environment 100 contains an example of an environment for the execution of at least some of the computer code in block 150 involved in performing the inventive methods, such as attribute-based calibration for machine learning (ABC/ML) framework 200 implemented as executable program code or instructions. ABC/ML framework 200 is capable of performing machine learning classifications based on unseen as well as seen attributes of objects. By comparison, some conventional machine learning methodologies and algorithms (e.g., ZSL, GZSL) assume that all attributes are seen during the training of a machine learning classifier model. While such methodologies and algorithms can classify unseen classes, the methodologies and algorithms assume that all attributes that are seen for unseen classes are also seen with at least some seen classes. ABC/ML framework 200 utilizes an entropy-based penalty in training a machine learning model. In contrast to conventional techniques, ABC/ML framework 200 applies the entropy-based penalty in the attribute domain rather than at the class level. ABC/ML framework 200 can be extended to handle dataset imbalances as well as predict unseen attributes. Applying the entropy-based penalty also lessens the problem of overfitting a machine learning model.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ABC/ML framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

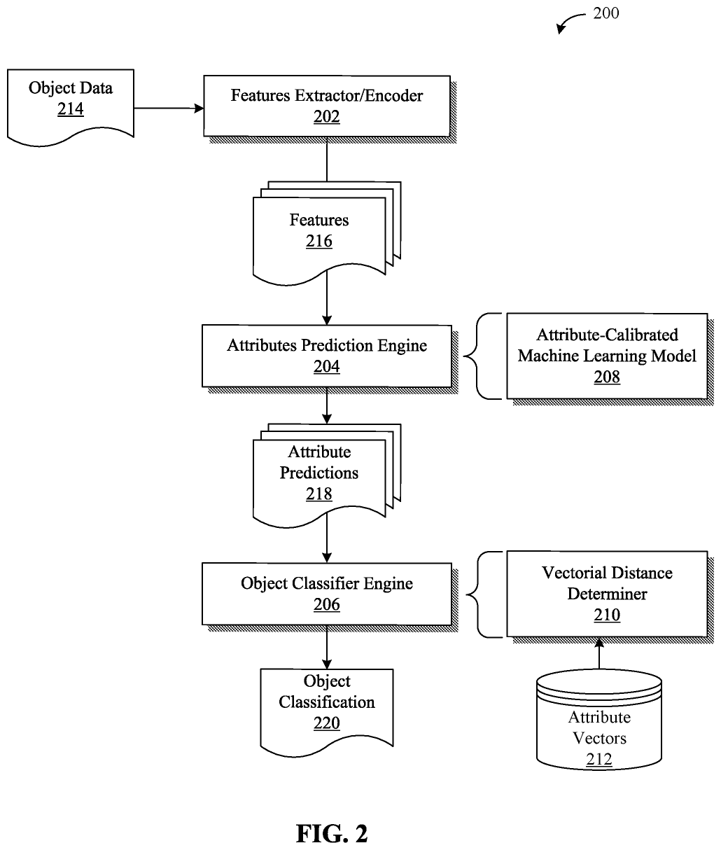

FIG. 2 illustrates an example architecture for the executable ABC/ML framework 200 of FIG. 1. In the example of FIG. 2, ABC/ML framework 200 illustratively includes features extractor/encoder 202, attributes prediction engine 204, and object classifier engine 206. Attributes prediction engine 204 implements attribute-calibrated machine learning model (ACMLM) 208. In some arrangements, object classifier engine 206 implements vectorial distance determiner 210, which communicatively couples with a database of attribute vectors 212.

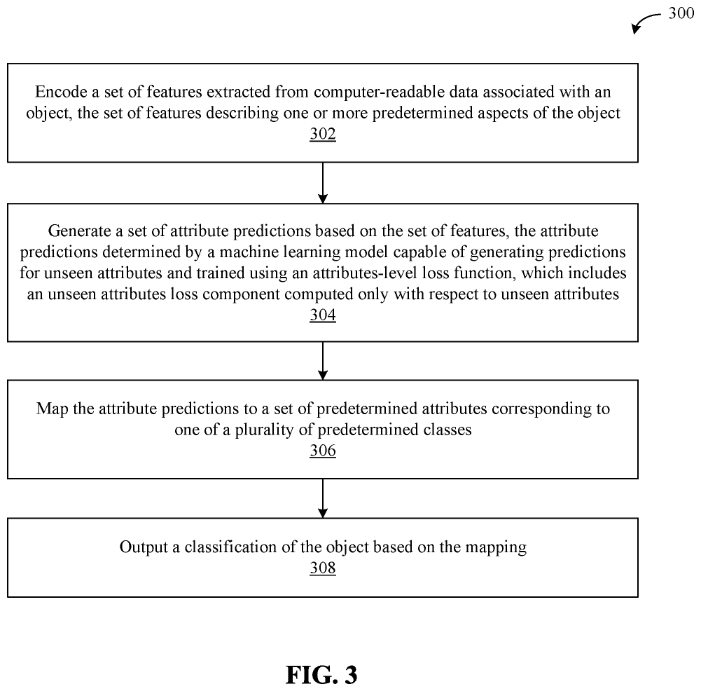

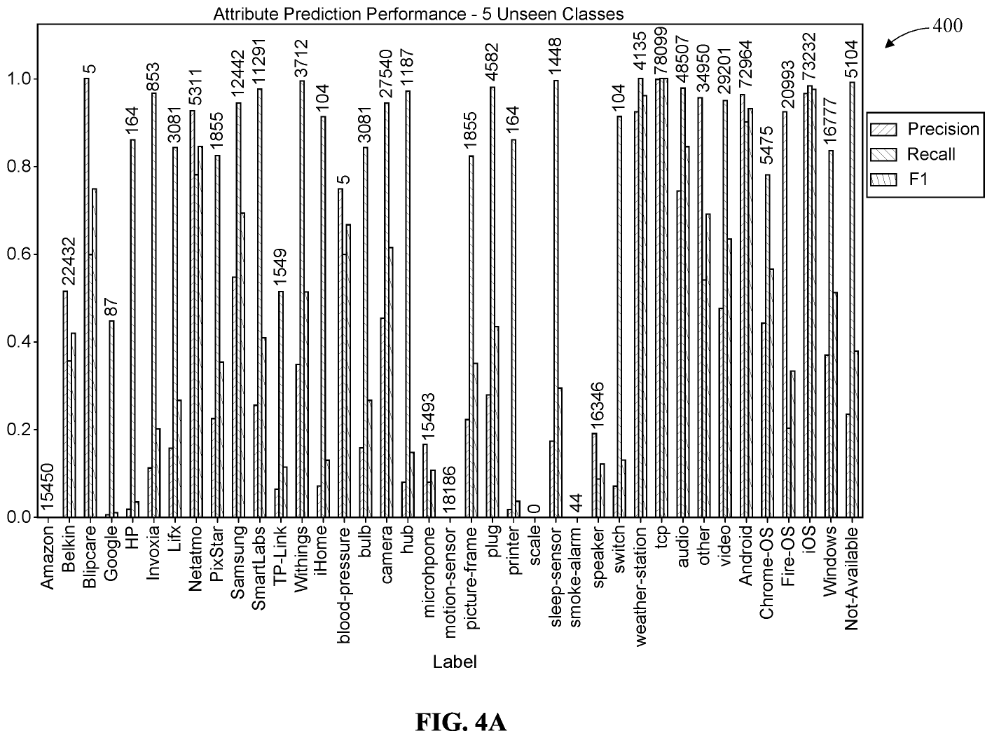

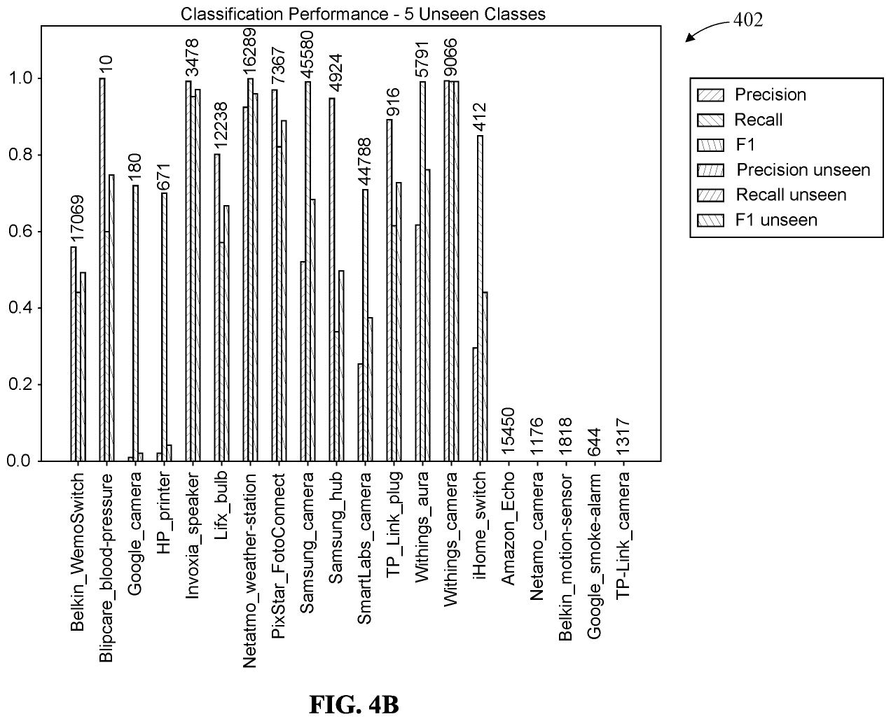

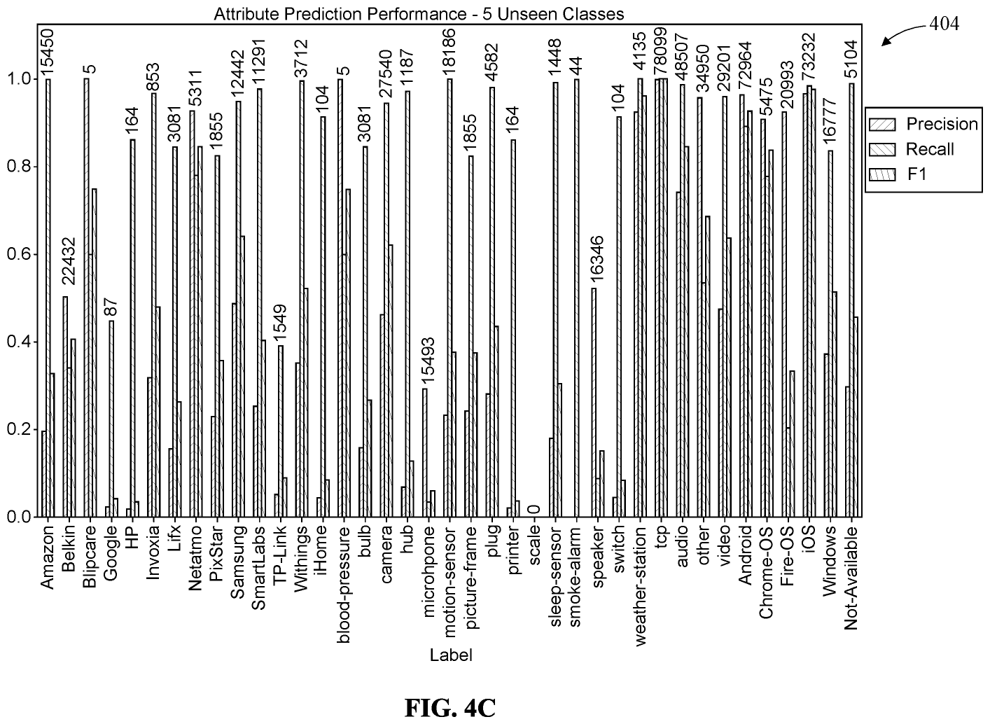

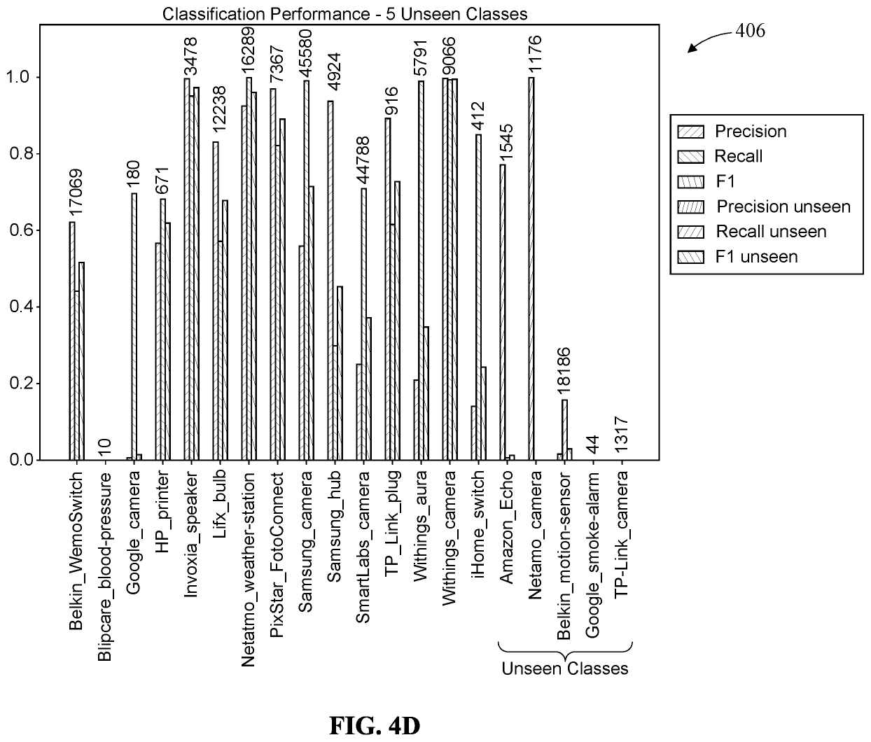

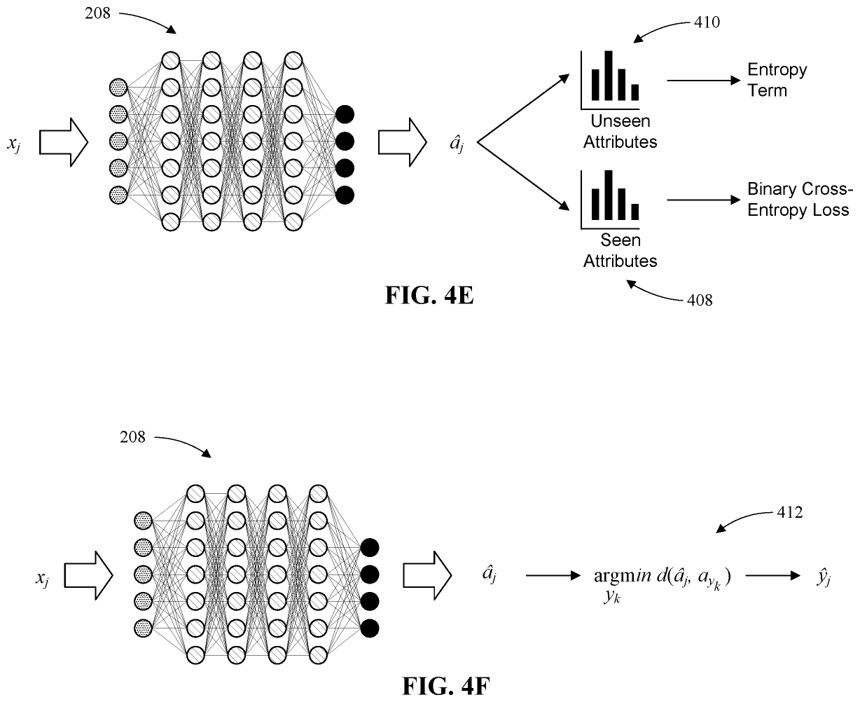

FIG. 3 illustrates an example method 300 of operation of the ABC/ML framework 200 of FIGS. 1 and 2. Referring jointly to FIGS. 2 and 3, in block 302, features extractor/encoder 202 receives object data 214, from which features extractor/encoder 202 extracts and encodes features 216. Object data 214 is computer-readable data associated with an object. The object can be text, images, sounds, network traffic, or IoT devices (see, e.g., FIGS. 4A-4D), for example. ABC/ML framework 200 is applicable to the classification of various other types of objects, as well. Features 216 comprises a set of features that describe one or more predetermined aspects of different classes of objects. For example, features 216 of images can comprise numerical values corresponding to the intensity, brightness, and/or color of the pixels of the images. Features 216 of IoT devices can comprise coded values indicating a type, model, and maker of the IoT devices, for example (FIGS. 4A-4D).

In block 302, features 216 can be encoded by features extractor/encoder 202 as data structures for input to a machine learning model. Accordingly, in various arrangements, features extractor/encoder 202 can encode features 216 as a vector, matrix, or higher-order tensor. Features extractor/encoder 202 inputs features 216 to attributes prediction engine 204.

Attributes prediction engine 204 operates as an attribute classifier. Accordingly, attributes prediction engine 204 generates attribute predictions 218—that is, predictions of the class or category to which an attribute belongs—using a machine learning model implemented by ACMLM 208. Various types of machine learning can be implemented in ACMLM 208. ACMLM 208, in certain embodiments, can implement a deep learning NN. In other embodiments, ACMLM 208 can implement a shallow machine learning model, such as a support vector machine (SVM) or Boosting model, for example.

In block 304, attributes prediction engine 204 generates attribute predictions 218 based on features 216. ACMLM 208 is capable of generating predictions for unseen attributes. The capability stems from training ACMLM 208 using supervised learning that incorporates an attributes-level loss function, which includes an unseen attributes loss component that is computed only with respect to unseen attributes. The unseen attributes loss component penalizes high-certainty predictions during ACMLM 208's learning phase. Penalizing high certainty predictions of zero probability score for unseen attributes of examples eliminates or mitigates the tendency that ACMLM 208 would otherwise never (or almost never) predict any unseen attribute during the test phase and in subsequent, post-training operation of the model. Having never seen an unseen attribute during training, ACMLM 208 would otherwise almost certainly predict that there is no unseen attribute present. That the presence of an unseen attribute has zero probability. Penalizing highly certain predictions obviates the tendency to never predict an unseen attribute by ACMLM 208.

Using supervised machine learning, ACMLM 208 “learns” a multi-label attribute classifier ƒ_{θ}(xₙ) by iteratively adjusting parameter θ for inputs xₙ, n=1, . . . , N, until the attributes-level loss function is reduced to an acceptable error rate. The attributes-level loss function includes an unseen attributes loss component that, as described above, operates to penalize high-certainty predictions during supervised learning. In certain arrangements, the attributes-level loss function includes both a seen attributes loss component and an unseen attributes loss component. Because multiple attributes may be present simultaneously, the seen attributes loss component can be a binary cross-entropy loss term L computed over seen attributes a_{n,i}, i=1, . . . , A:

L=−Σₙ₌₁^{N}Σᵢ₌₁^{A}a_{n,i} log pᵢ(xₙ).

In other arrangements, other loss terms can be used for the seen attributes loss component, such as mean square error (MSE). Using only a seen attributes loss component in the attributes-level loss function, however, would leave ACMLM 208 “blind” to unseen attributes U. Accordingly, ABC/ML framework 200 incorporates the unseen attributes loss component into the attributes-level loss function of ACMLM 208. In certain arrangements, the unseen attributes loss component is an entropy-based loss term H:

H=−Σₙ₌₁^{N}Σᵢ₌₁^{U}qᵢ(xₙ)log qᵢ(xₙ),

where qᵢ is the predicted distribution over unseen attributes U. ACMLM 208 is jointly trained to minimize both the seen attributes loss component and the unseen attributes loss component. Thus, in certain arrangements, the attributes-level loss function for training ACMLM 208 can be formulated as

$${min}_{θ} L + λ H ,$$

where the entropy-based loss term H only applies with respect to unseen attributes and coefficient λ is an optional weighting term applied to the entropy-based loss term H.

In some embodiments, ACMLM 208 can be configured to interpret attributes that are unseen during training as a relatively extreme instance of dataset imbalance. Dataset imbalance arises when one or more classes of examples are very sparsely represented relative to the other classes of examples. This can occur, for example, in the context of classifying network traffic data. The unseen attributes loss component H can be multiplied by weighting coefficient λ selected to mitigate an imbalance among the set of training examples used to ACMLM 208. For instance, for highly imbalanced datasets such as the network traffic data, the weighted entropy term can be applied across all attributes, seen and unseen, to address dataset imbalance.

In block 306, object classifier engine 206 maps attribute predictions 218 to one of a plurality of predetermined classes. Each class can correspond to a predetermined set of attributes. Object classifier engine 206 maps attribute predictions 218 of the object to the most similar predetermined attributes of a particular class. Attribute predictions 218, in certain arrangements, are prediction scores (e.g., between zero and one), where the higher the score for an attribute, the more likely that the object to be classified is characterized by the attribute. Each class can be characterized by a binary vector, each of whose elements corresponds to an attribute of a specific class. A class is characterized as having a particular attribute if the vector element corresponding to the attribute has a value of one. A value of zero indicates that the attribute is not associated with that class.

In some embodiments, object classifier engine 206 classifies an object based on a closeness of a vector of the predicted attributes to a binary vector corresponding to a particular class. The degree of closeness between a pair of vectors can be determined by vectorial distance determiner 210 of object classifier engine 206. A plurality of binary vectors, each uniquely associated with a particular class, can be pre-stored in the database of attributes vectors 212. Vectorial distance determiner 210 determines closeness based on a cosine similarity or inner product distance. The object is classified as belonging to the class whose corresponding binary vector has the smallest cosine or inner product distance to the object's vector of predicted attributes.

In other embodiments, predicted attributes 218 are input to an additional machine learning model separate from the one implemented by ACMLM 208. The additional machine learning model, in certain arrangements, is a deep learning NN. In other arrangements, the additional machine learning model is a shallow machine learning model, such as an SVM or Boosting model, for example.

In block 308, object classifier engine 206 outputs object classification 220. Object classification 220 can classify an image, text, sound, or IoT device, for example, or another type of object.

A specific example of object classification 220 is a classification of images indicating whether the image is likely that of a horse, whale, zebra, or bird. Features 216 can be vectors (feature vectors), the elements which correspond to image statistics, such as color histogram, edges distribution, pixel intensities, pixel brightness, and the like. The numeric values of the elements of each vector depend on the class to which the corresponding image belongs. Attribute vectors 212 represent the predetermined attributes of the different classes and can be structured as binary vectors. The values of the binary elements of attributes vectors 212 represent the presence or absence of the predetermined attributes that characterize each class. A one indicates that a class exhibits the corresponding attribute. A zero indicates that the corresponding attribute is not present in images of that class.

Illustratively, the predetermined attributes can be striped, has_4_legs, has_2_legs, has_legs, has_wings, has_tail, and has_fins. The seen attributes of a set of training samples (examples) for training ACMLM 208 may include has_4_legs, has_legs, has_tail, and has_fins. Accordingly, the unseen attributes of the set of examples are has_2_legs and has_wings. That is, the attributes has_2_legs and has_wings do not belong to any of the seen classes (horse, whale, zebra, and bird). During training, ACMLM 208 never “sees” an example for which the attributes include 2_legs and/or has_wings. ACMLM 208 learns to generate predictions (values between zero and one) for the attributes of a target (test phase or post-training example).

Based on attribute predictions 218 (structured as a predicted attributes vector), vectorial distance determiner 210 of object classifier engine 206 determines the closest binary vector. The determination is based on the binary vector elements associated with both seen and unseen classes that have a value of one. Based on the determined closeness, object classifier engine 206 outputs object classification 220, which classifies an image as being a horse, whale, zebra, or bird.

Illustratively, at test time, if object data 214 corresponds to an image of a bird, features extractor/encoder 202 extracts features and encodes the features as feature vectors. Attributes prediction engine 204 applies ACMLM 208, which generates attributes predictions 218 predicting which attributes are present for the object corresponding object data 214. If the predictions (whose values are indicated in the parentheses) are striped (0.2), has_4_legs (0.02), has_2_legs (0.35), has_legs (0.99), has_wings (0.4), has_tail (0.98), has_fins (0.01), then the closest binary vector elements have the values (indicated in the parentheses) striped (0), has_4_legs (0), has_2_legs (1), has_legs (1), has_wings (1), has_tail (1), has_fins (0), which corresponds to the animal class bird. Therefore, object classification 220 is bird.

FIGS. 4A-4F illustrate an example experiment that compares the predictive performance of a computer implementation of ABC/ML framework 200 with that of a GZSL implementation in classifying IoT devices based on certain seen and unseen attributes. Classifying IoT devices is performed in the specific context of detecting and recognizing IoT devices that are newly connected or are attempting to connect to a network, the classifying based on the IoT devices' network behavior. The experiment illustratively includes pre-processing a dataset containing 391,680 examples with 49 features, describing the IoT devices' network behavior. The dataset consists of 20 classes of IoT devices with 38 attributes. The 38 attributes of each IoT class describe characteristics, such as the brand, operating system, and available internet protocols. For the experiment, the GZSL is trained to predict attributes based on the features of the IoT devices. The attribute predictions are mapped to classes by finding the class with the minimum cosine or inner product distance to the predicted attributes.

In repeated trials, 5 unseen classes (Amazon_Echo, Netatmo_Camera, Belkin_motion-sensor, Google_smoke-alarm, TP-Link_camera) are considered, including three attributes that are unseen (Amazon, motion-sensor, smoke-alarm). Chart 400 of FIG. 4A and chart 402 of FIG. 4B show, respectively, the attribute prediction performance and classification performance of the GZSL trained without an entropy term. The GZSL's predictive performance is zero for all 5 of the unseen classes, and none of the unseen attributes are predicted to be present by the GZSL

Chart 404 of FIG. 4C and chart 406 of FIG. 4D show, respectively, the attribute prediction performance and classification performance of attribute predictions and IoT classifications using ABC/ML framework 200, which includes ACMLM 208 implemented by attributes prediction engine 204. For the experiment, ACMLM 208 learns to classify IoT devices based on seen and unseen attributes. The attributes-level loss function of ACMLM 208, as described above, incorporates a seen attributes loss component and an unseen attributes loss component. FIG. 4E schematically illustrates the training of ACMLM 208 in the experiment. Illustratively, in FIG. 4E, the seen attribute loss component is binary cross-entropy loss 408 and the unseen attribute loss component of the attributes-level loss function is entropy term 410. FIG. 4F schematically illustrates predictions 412 generated by ACMLM 208 at test time. ACMLM 208 predicts a plurality of attributes âⱼ, j=1, . . . , 38, (e.g., arrayed as a vector of prediction scores) of an IoT device based on the 49 features of the i-th input \hat{x}ᵢ, i∈{1; . . . ; 391,680}, (e.g., arrayed as a feature vector) corresponding to the IoT device. Object classifier engine 206 classifies the IoT device by mapping the attribute predictions to one of the 20 predetermined classes of IoT devices. Illustratively, in FIG. 4F, the attribute predictions âⱼ, arrayed as a vector of prediction scores, map to the nearest binary vector a_{y}_{ₖ}, k∈{1, . . . , 20}, of attributes for a specific class of IoT device, the minimum distance

$${arg min}_{{y}_{k}} d ( {\hat{a}}_{j} , {a}_{{y}_{k}} )$$

determined by vectorial distance determiner 210 of object classifier engine 206.

As shown by chart 404 of FIG. 4C and chart 406 of FIG. 4D, ACMLM 208's incorporation of an entropy term 410 improves the predictive performance with respect to unseen attributes as compared to the GZSL. ACMLM 208's enhanced predictive performance with respect to the unseen attributes, in turn, improves the classifying of the unseen classes. ABC/ML framework 200's predictive performance is an improvement over the GZSL for three of the five unseen classes and stays constant for most of the seen classes. The average performance of ABC/ML framework 200, as measured by the average F1 score, increases both overall and in particular for the unseen attributes as compared to that of the GZSL. ABC/ML's F1 score for all attributes increases from 0.404 to 0.437, while the F1 score for unseen attributes increases significantly from 0 to 0.236.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
encoding, with computer hardware, a set of features extracted from computer-readable data associated with an object, wherein the set of features describes one or more predetermined aspects of the object;
generating, using the computer hardware, a set of attribute predictions based on the set of features, wherein the set of attribute predictions is determined by a machine learning model that is capable of generating predictions for unseen attributes and that is trained using an attributes-level loss function that includes an unseen attributes loss component that is computed only with respect to unseen attributes;
mapping, using the computer hardware, the set of attribute predictions to a set of predetermined attributes corresponding to one of a plurality of predetermined classes; and
outputting, using the computer hardware, a classification of the object based on the mapping.

2. The method of claim 1, wherein the attributes-level loss function includes a seen attributes loss component that is computed only with respect to seen attributes, and wherein attributes-level loss function measures prediction errors in training the machine learning model by summing the seen attributes loss component and the unseen attributes loss component.

3. The method of claim 2, wherein prior to summing the seen attributes loss component and the unseen attributes loss component, the unseen attributes loss component is multiplied by a weighting coefficient selected to mitigate an imbalance among a set of training examples used to train the machine learning model.

4. The method of claim 2, wherein the unseen attributes loss component is an entropy-based loss, and wherein the seen attributes loss component is binary cross-entropy loss.

5. The method of claim 2, wherein the unseen attributes loss component is an entropy-based loss, and wherein the seen attributes loss component is a mean squared error (MSE).

6. The method of claim 1, wherein the mapping is based on a distance between a vector representation of the attribute predictions and a binary vector corresponding to the one of the plurality of predetermined classes.

7. The method of claim 1, wherein the mapping is performed using an additional machine learning model.

8. The method of claim 1, further comprising:
outputting a notification that the object corresponds to a new class, wherein the notification is generated in response to determining that the object does not correspond to any of the plurality of predetermined classes.

9. The method of claim 8, further comprising:
outputting one or more identities of attributes of the new class.

10. A system, comprising:
a processor configured to initiate operations including:
encoding a set of features extracted from computer-readable data associated with an object, wherein the set of features describes one or more predetermined aspects of the object;
generating a set of attribute predictions based on the set of features, wherein the set of attribute predictions is determined by a machine learning model that is capable of generating predictions for unseen attributes and that is trained using an attributes-level loss function that includes an unseen attributes loss component that is computed only with respect to unseen attributes;
mapping the set of attribute predictions to a set of predetermined attributes corresponding to one of a plurality of predetermined classes; and
outputting a classification of the object based on the mapping.

11. The system of claim 10, wherein the attributes-level loss function includes a seen attributes loss component that is computed only with respect to seen attributes, and wherein attributes-level loss function measures prediction errors in training the machine learning model by summing the seen attributes loss component and the unseen attributes loss component.

12. The system of claim 11, wherein prior to summing the seen attributes loss component and the unseen attributes loss component, the unseen attributes loss component is multiplied by a weighting coefficient selected to mitigate an imbalance among a set of training examples used to train the machine learning model.

13. The system of claim 11, wherein the unseen attributes loss component is an entropy-based loss, and wherein the seen attributes loss component is binary cross-entropy loss.

14. The system of claim 11, wherein the unseen attributes loss component is an entropy-based loss, and wherein the seen attributes loss component is a mean squared error (MSE).

15. The system of claim 10, wherein the mapping is based on a distance between a vector representation of the attribute predictions and a binary vector corresponding to the one of the plurality of predetermined classes.

16. The system of claim 10, wherein the mapping is performed using an additional machine learning model.

17. The system of claim 10, wherein the processor is configured to initiate operations further including:
outputting a notification that the object corresponds to a new class, wherein the notification is generated in response to determining that the object does not correspond to any of the plurality of predetermined classes.

18. The system of claim 17, wherein the processor is configured to initiate operations further including:
outputting identities of attributes of the new class.

19. A computer program product, the computer program product comprising:
one or more computer-readable storage media and program instructions collectively stored on the one or more computer-readable storage media, the program instructions executable by a processor to cause the processor to initiate operations including:
encoding a set of features extracted from computer-readable data associated with an object, wherein the set of features describes one or more predetermined aspects of the object;
generating a set of attribute predictions based on the set of features, wherein the set of attribute predictions is determined by a machine learning model that is capable of generating predictions for unseen attributes and that is trained using an attributes-level loss function that includes an unseen attributes loss component that is computed only with respect to unseen attributes;
mapping the set of attribute predictions to a set of predetermined attributes corresponding to one of a plurality of predetermined classes; and
outputting a classification of the object based on the mapping.

20. The computer program product of claim 19, wherein the attributes-level loss function includes a seen attributes loss component that is computed only with respect to seen attributes, and wherein attributes-level loss function measures prediction errors in training the machine learning model by summing the seen attributes loss component and the unseen attributes loss component.
